(19) United States
(12) Patent Application Publication
(10) Pub. No.: US 2018/0015596 A1
(43) Pub. Date: Jan. 18, 2018

(54) SCREW AND FASTENING TOOL OF SCREW

(71) Applicant: Chang Hun KIM, Incheon (KR)

(72) Inventor: Chang Hun KIM, Incheon (KR)

(21) Appl. No.: 15/281,373

(22) Filed: Sep. 30, 2016

(30) Foreign Application Priority Data
Jul. 13, 2016 (KR) 10-2016-0088640

(51) Int. Cl. B25B 15/00; B25B 23/00; B25B 21/00; F16B 23/00; B25B 13/06

(52) U.S. Cl. CPC B25B 15/005; F16B 23/0023; B25B 13/06; B25B 21/00; B25B 23/0035

(57) ABSTRACT

A screw and a fastening tool of a screw are disclosed. The screw has a cross-shaped tool insertion groove formed on a head part and a holding groove formed on one side inner surface of the tool insertion groove, so as to be assembled with a cap having a cross-shaped fitting part and a holding protrusion provided at one side of the fitting part. The fastening tool includes a first linear insertion part and a second insertion part, which are configured to be fitted into the tool insertion groove, wherein the first and second insertion parts are perpendicular. As the fastening tool fitted into the head part of the screw is rotated, the rotation torque is uniformly dispersed over the four corner portions of the tool insertion groove through the first and second insertion parts, thereby avoiding abrasion of the tool insertion groove and extending the lifespan of the screw.

### BACKGROUND OF THE INVENTION

### Technical Field

The present invention relates to a screw and a fastening tool of a screw, in which fastening force can be evenly transmitted throughout a tool insertion groove on the head part of a screw when coupling or releasing the screw such that the tool insertion groove of the head part is not likely to be worn out in spite of repetitive use and the screw and the fastening tool of such a screw can be used for a long time.

### Background Art

In general, screws are used for joining objects, such as plates made from wood, synthetic resin, steel and the like, to each other, wherein the screws are considered to have considerably strong coupling force compared with nails since the screws are rotatively stuck in the objects owing to the thread part thereof.

The screws are typically divided into pan head screws, flat head screws, round head screws and the like according to the shape of the head parts thereof, and include straight slot-shaped or cross-shaped tool insertion grooves formed on the head parts such that tools for fastening such screws also include slot-shaped or cross-shaped insertion parts formed on the front end portions thereof.

As one of such prior art screws, Korean utility model laid-open publication No. 20-2010-0005204 (published on 20 May 2010) suggests a screw, which includes a cross-shaped tool insertion groove formed on the head part thereof such that a tool having a cross-shaped front end is inserted into the cross-shaped tool insertion groove of the screw so as to turn the screw in the clockwise or counterclockwise direction, thereby fastening or releasing the screw.

The cross-shaped tool insertion groove formed on the head part disperses the rotation torque of a driver tool uniformly in every direction. However, this prior art screw has a problem that the tool insertion groove of the head part is likely to be worn out when the insertion part of a tool is fitted onto the tool insertion groove and rotated to fasten or release the screw, since the tool insertion groove is formed in a shape, in which the tool insertion groove is slanted and concentrated on the center thereof.

Furthermore, there is another prior art screw disclosed in Korean registered utility model No. 20-0390103 (published on 18 Jul. 2005, “structure of driver and screw”), relating to a structure of a slot-shaped screw and a driver thereof, in which an indented groove part of a screw is protected from easy abrasion so as to increase durability and easily transmit the rotation force of a driver.

However, this prior art still has a problem that the rotation torque of the driver is only applied to the both ends of the indented groove part such that the both ends of the indented groove part of the screw are apt to be worn out by the repetitive use of the driver and thus the driver runs idle.

### PRIOR ART DOCUMENTS

### Patent Documents

Korean utility model laid-open publication No. 20-2010-0005204 (published on 20 May 2010), “screw”
Korean registered utility model publication No. 20-0390103 (published on 18 Jul. 2005), “structure of driver and screw”

### SUMMARY OF THE INVENTION

### Problems that the Invention is to Solve

Accordingly, the present invention has been derived to solve the above-mentioned problems and disadvantages occurring in the prior arts, and it is an objective of the present invention to provide a screw capable of preventing the easy abrasion of a tool insertion groove on a head part, in which the structure of the head part of a screw is complemented so as to disperse the rotation torque in every direction such that the rotation torque is evenly transmitted in every direction on the tool insertion groove in spite of repetitive use and accordingly a tool for fastening the screw can accurately operate without idling.

It is another objective of the present invention to provide a fastening tool of a screw, which can more uniformly transmit the rotation torque over the head part of a screw so as to minimize the wear rate of the tool insertion groove of the screw.

### Means for Solving the Problems

To accomplish the above objectives, according to one aspect of the present invention, there is provided a screw, which includes a shank having a coil type spiral part formed at the upper portion of a tip part and a head part provided at one side of the shank, characterized in that a cross-shaped tool insertion groove is formed with a predetermined depth on the surface of the head part up to a peripheral side surface part, a holding groove is formed on one side inner surface of the tool insertion groove, and a cap has a cross-shaped fitting part, which is formed on the bottom surface thereof so as to be fitted into the tool insertion groove, and a holding protrusion, which is formed at one side of the fitting part so as to be coupled to the holding groove, such that the cap is stably assembled into the head part, which is exposed to the outside of an object to be joined.

To accomplish the above objectives, according to another aspect of the present invention, there is provided a fastening tool of a screw, which has a cross-shaped tool insertion groove that is formed on the surface of a head part up to a peripheral side surface part and a holding groove that is formed on one side inner surface of the tool insertion groove such that a cap, which has a cross-shaped fitting part that is formed on the bottom surface thereof and a holding protrusion that is provided at one side of the fitting part, can be assembled with the screw, characterized in that a first linear insertion part to be linearly inserted into the cross-shaped tool insertion groove of the screw head part is formed at the lower end of a rod of a fastening tool body, which is used in a driver, a socket wrench or an electric tool, and a second insertion part to be fitted into the remaining portion of the tool insertion groove is formed in the center of the first insertion part so as to be perpendicular to the first insertion part and form a cross shape together with the first insertion part.

As for the screw according to the present invention as described above, the first insertion part and the second insertion part of the fastening tool body generally come into close and uniform contact with the cross-shaped tool insertion groove of the screw head part so as to be fitted thereinto and, if the fastening tool body is rotated in this fitted state, the rotation torque thereof is uniformly dispersed and acts on the four corner portions of the tool insertion groove through the first insertion part and the second insertion part, which are formed in the cross-shape, such that the tool insertion groove of the head part is not easily worn out, thereby extending the lifespan of the screw, wherein the appearance of the screw is improved when the cap is assembled thereinto.

In addition, as for the fastening tool of such a screw, according to the present invention as described above, the first insertion part and the second insertion part form the cross-shape at the lower end of the fastening tool body, wherein the first insertion part disperses and transmits the rotation torque to the end edge portions of the tool insertion groove of the screw and the second insertion part disperses and transmits the rotation torque to the center portion of the tool insertion groove such that the screw can be stuck in or released from an object without the damage to the head part of the screw.

### BRIEF DESCRIPTION OF DRAWINGS

FIG. 1a is a perspective view for showing a screw and a cap, which are separated from each other, according to a preferred embodiment of the present invention.

FIG. 1b is a perspective view for showing a coupling state of the screw and the cap according to a preferred embodiment of the present invention.

FIG. 1c is a cross-sectional view for showing the coupling state of the screw and the cap according to the present invention.

FIG. 2 is a perspective view for showing a driver for implementing a fastening tool of a screw according to a preferred embodiment of the present invention.

FIG. 3 is a perspective view for showing a socket wrench for implementing a fastening tool of a screw according to a preferred embodiment of the present invention, and

FIG. 4 is a perspective view for showing a driver bit of an electric tool for implementing a fastening tool of a screw according to a preferred embodiment of the present invention

Brief Explanation of Reference Symbols

| 100: shank | 101: tip part |
|---|---|
| 102: spiral part | 103: head part |
| 104: tool insertion groove | |
| 105: peripheral side surface part | |
| 106: holding groove | 110: cap |
| 111: fitting part | 112: holding protrusion |
| 200: fastening tool body | 201: rod |
| 210: first insertion part | 220: second insertion part |

### DETAILED DESCRIPTION OF THE PREFERRED EMBODIMENT

Hereinafter, the technical features and operations, capable of effectively achieving the objectives of the present invention will be described in detail and reference will be now made to the preferred embodiments of the present invention with reference to the attached drawings.

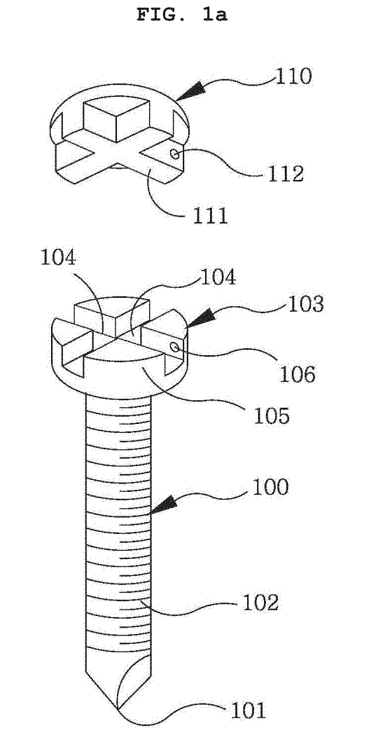

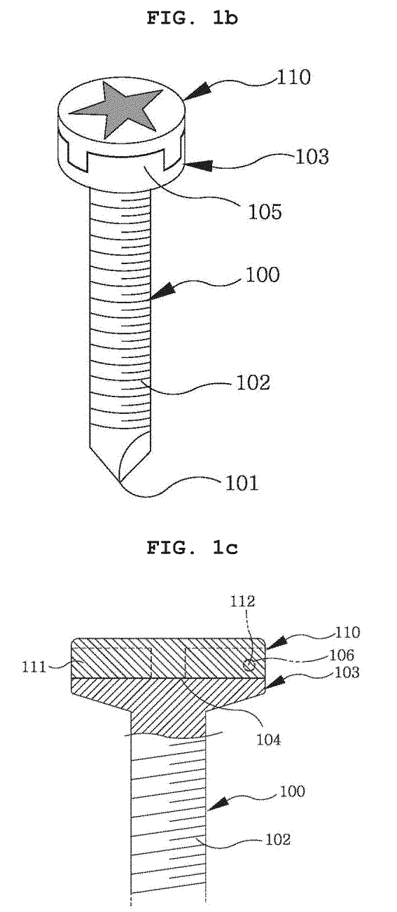

FIG. 1a is a perspective view for showing a screw and a cap, which are separated from each other, according to a preferred embodiment of the present invention, and FIG. 1b is a perspective view for showing the screw and the cap, which are coupled to each other, according to a preferred embodiment of the present invention. Referring to FIG. 1a and FIG. 1b, a screw according to a preferred embodiment of the present invention includes a shank 100 having a coil type spiral part 102, which is formed at the upper portion of a tip part 101, and a head part 103 provided at one side of the shank 100, in the same manner as the prior art.

According to the features of the present invention, a cross-shaped tool insertion groove 104 is formed with a predetermined depth on the surface of the head part 103 up to a peripheral side surface part 105, a holding groove 106 is formed on one side inner surface of the tool insertion groove 104, and a cap 110 is provided and has a cross-shaped fitting part 111, which is formed on the bottom surface thereof so as to be fitted into the tool insertion groove 104, and a holding protrusion 112, which is formed at one side of the fitting part 111 so as to be coupled to the holding groove 106, such that the cap 110 is stably assembled into the head part 103, which is exposed to the outside of an object to be joined.

If the screw according to the present invention described as above is rotated in a state, in which a first insertion part 210 and a second insertion part 220, the both forming the cross-shape of a fastening tool, which will be described in detail below, are fitted into the cross-shaped tool insertion groove 104 formed with a predetermined depth on the surface of the head part 103 up to the peripheral side surface part 105, then the surfaces of the fitting part 111 thoroughly come into close contact with the surfaces of the tool insertion groove 104 and accordingly the rotation torque of the fastening tool is uniformly transmitted such that the tool insertion groove 104 is not easily worn out so as to be repetitively used for a long time.

Further, if the cap 110 is assembled into the head part 103 of the screw after the screw is stuck in an object to be joined, the cap 110 is maintained on the head part 103 in a stably assembled state by the coupling between the holding groove 106 and the holding protrusion 112 and the head part 103, which is exposed to the outside of the object to be joined, is covered by the cap 110 such that the whole appearance of the screw and the object becomes improved.

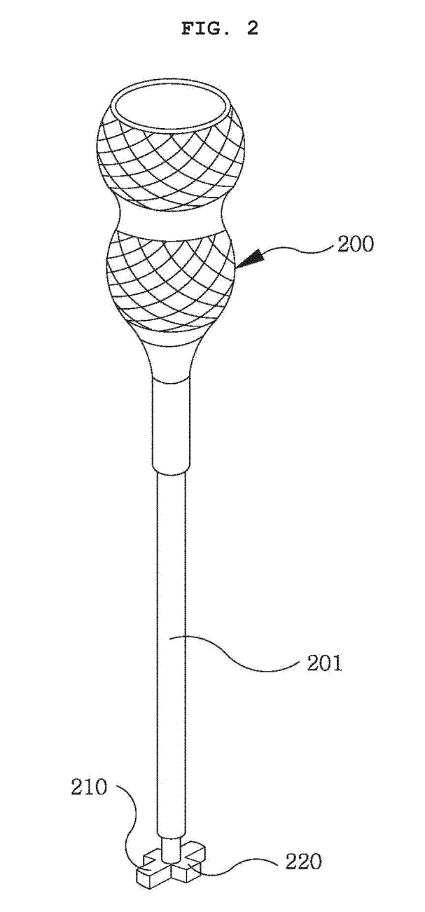

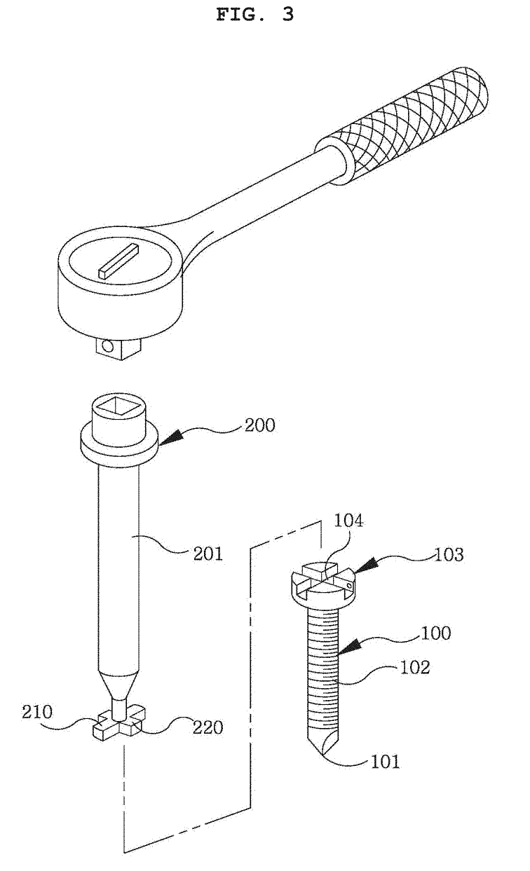

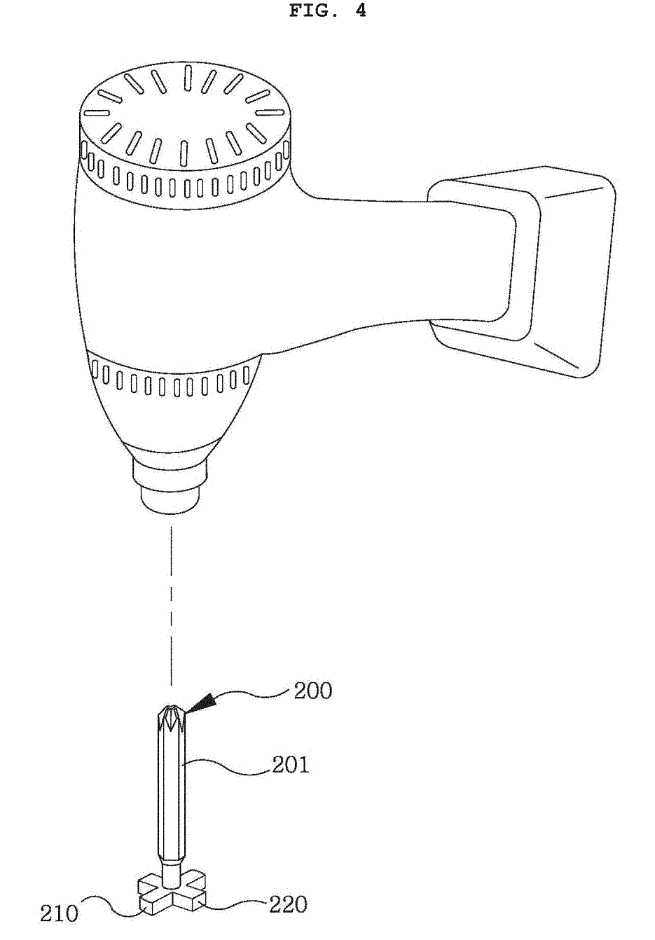

FIG. 2 is a perspective view for showing a driver for implementing a fastening tool of a screw according to a preferred embodiment of the present invention, and FIG. 3 is a perspective view for showing a socket wrench for implementing a fastening tool of a screw according to a preferred embodiment of the present invention.

As shown in FIG. 2 and FIG. 3, a fastening tool of a screw according to the present invention can be implemented with respect to a general driver as shown in FIG. 2 or a socket wrench as shown in FIG. 3, wherein a first linear insertion part 210 to be linearly inserted into the cross-shaped tool insertion groove 104 of the screw head part 103 is formed at the lower end of a rod 201 of a fastening tool body 200, which forms a driver or a socket wrench, and a second insertion part 220 to be fitted into the remaining portion of the tool insertion groove 104 is formed in the center of the first insertion part 210 so as to be perpendicular to the first insertion part 210 and form a cross shape together with the first insertion part 210.

Herein, FIG. 4 is a perspective view for showing a driver bit of an electric tool for implementing a fastening tool of a screw according to a preferred embodiment of the present invention. As shown in FIG. 4, a fastening tool of a screw, according to the present invention, has a fastening tool body 200 for serving as a driver bit coupled to an electric tool, wherein the fastening tool body 200 has the first insertion part 210 and the second insertion part 220, which are formed in a cross-shape at the lower end of the fastening tool body 200.

According to the present invention, if the first insertion part 210 and the second insertion part 220, which are formed in a cross-shape at the lower end of the fastening tool body 200, are fitted into the cross-shaped tool insertion groove 104 of the screw head part 103, then the first insertion part 210 and the second insertion part 220 in a cross-shape thoroughly come into contact with the tool insertion groove 104 in the corresponding cross-shape. If the rotation torque is generated in this state, the cross-shaped first and second insertion parts 210, 220 rotate while strongly pressing the four corner portions of the tool insertion groove 104 such that the rotation torque is uniformly dispersed and acts on the four positions.

Therefore, the tool insertion groove 104 of the head part 103 is not easily worn out as the prior art screws and thus can be repetitively used for a long time.

In the fastening tool of a screw, according to the present invention, it is more preferable that the second insertion part 220 is formed to be shorter than the first insertion part 210 so as to have a length of ⅓-⅔ of the first insertion part 210.

That is, the fastening tool of a screw rotates the screw while the first insertion part 210, which is longer than the second insertion part 220, transmits the rotation torque to the end edge portions of the tool insertion groove 104 of the head part 103 and the second insertion part 220, which is shorter than the firs insertion part 210, transmits the rotation torque to the center portion of the tool insertion groove 104 of the head part 103. Therefore, the screw can be very smoothly stuck in or released from an object to be joined.

Herein, the cap 110 can be formed in the shape of a circle, an octagon or a hexagon, and have a pattern such as a star, a soccer ball, a bird and the like on the surface thereof.

What is claimed is:

1. A screw, which includes a shank having a coil type spiral part formed at the upper portion of a tip part and a head part provided at one side of the shank, characterized in that:
a cross-shaped tool insertion groove is formed with a predetermined depth on the surface of the head part up to a peripheral side surface part;
a holding groove is formed on one side inner surface of the tool insertion groove; and
a cap has a cross-shaped fitting part, which is formed on the bottom surface thereof so as to be fitted into the tool insertion groove, and a holding protrusion, which is formed at one side of the fitting part so as to be coupled to the holding groove, such that the cap is stably assembled into the head part, which is exposed to the outside of an object to be joined.

2. A fastening tool of a screw, which has a cross-shaped tool insertion groove that is formed on the surface of a head part up to a peripheral side surface part and a holding groove that is formed on one side inner surface of the tool insertion groove such that a cap, which has a cross-shaped fitting part that is formed on the bottom surface thereof and a holding protrusion that is provided at one side of the fitting part, can be assembled with the screw, characterized in that:
a first linear insertion part to be linearly inserted into the cross-shaped tool insertion groove of the screw head part is formed at the lower end of a rod of a fastening tool body, which is used in a driver, a socket wrench or an electric tool; and
a second insertion part to be fitted into the remaining portion of the tool insertion groove is formed in the center of the first insertion part so as to be perpendicular to the first insertion part and form a cross shape together with the first insertion part.

3. The fastening tool of a screw according to claim 2, wherein the second insertion part is formed to be shorter than the first insertion part so as to have a length of ⅓-⅔ of the first insertion part, such that the first insertion part may disperse rotation torque to the ends of the tool insertion groove and the second insertion part may disperse rotation torque to the center portion of the tool insertion groove.
